(19) United States
(12) Patent Application Publication
(10) Pub. No.: US 2025/0307069 A1
(43) Pub. Date: Oct. 2, 2025

(54) SAFETY DATA INTEGRITY CHECKING AT A PARALLEL PROCESSOR OF A DISPLAY SYSTEM

(71) Applicant: ADVANCED MICRO DEVICES, INC., Santa Clara, CA (US)

(72) Inventors: Venkatesh Natarajan, Austin, TX (US); Ravi Kumar, Bangalore (IN)

(21) Appl. No.: 18/616,977

(22) Filed: Mar. 26, 2024

(51) Int. Cl. G06F 11/10; G09G 3/20

(52) U.S. Cl. CPC G06F 11/1004; G09G 3/2096; G09G 2340/12; G09G 2370/00; G09G 2380/10

(57) ABSTRACT

A display system increases a number of supported regions of interest and allowing for a dynamic background image by offloading region of interest calculations and data integrity checks from a display controller to a parallel processor of the display system. The parallel processor calculates a configurable number of regions of interest of a frame and error checks each of the regions of interest before transmitting the frame to the display controller.

### BACKGROUND

A processing system executing display applications generates images for display. In some instances, one or more portions of the image have a relatively high criticality level. For example, in a vehicle, such as an automobile, a processing system may generate an image for display to a driver, where some portions of the image have relatively low importance (e.g., a portion that displays an external temperature or a portion that displays media being played by the automobile) and other portions of the image have relatively high importance (e.g., a portion that displays a warning message that the engine temperature is too high). Such high importance or safety-critical portions of the image are referred to herein as regions of interest (ROI) and are used to display warnings or “tell-tale” icons that may impact the safety of the driver or passengers. However, errors in image generation can result in the more critical portions of the image being improperly generated or displayed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a display system in which region of interest data integrity checking is processed at a parallel processor in accordance with some embodiments.

FIG. 2 is an illustration of a display image having multiple regions of interest in accordance with some embodiments.

FIG. 3 is a block diagram illustrating increasing availability of display controller pipes by offloading region of interest functionality to a parallel processor in accordance with some embodiments.

FIG. 4 is a block diagram illustrating data integrity checking for regions of interest at a parallel processor in accordance with some embodiments.

FIG. 5 is a block diagram illustrating redundant data integrity checking at a parallel processor in accordance with some embodiments.

FIG. 6 is a flow diagram illustrating a method for checking safety critical data integrity at a parallel processor of a display system in accordance with some embodiments.

### DETAILED DESCRIPTION

Regions of interest (ROI) are portions of an image that have relatively high importance, such as safety-critical warning indicators (e.g., tire pressure, brake light on, collision warning, etc.). Typically, the number of ROIs that can be displayed at a display device (also referred to herein as a display) is limited by fixed function hardware in a display pipe of a display controller that drives the display device and the number of display devices that can be receive image data from the display controller is limited by a number of display pipes of the display controller that drives the display devices. In addition, the display controller is typically tasked with ensuring data integrity of the ROIs by, for example, calculating a cyclic redundancy check (CRC) and comparing it to a reference CRC, or performing a checksum, hash, or other data integrity check on each ROI.

A display controller typically includes fixed function hardware to perform data integrity checks, such that increasing the number of ROIs requires a corresponding increase in the fixed function hardware included in the display controller, thus adding to the area and complexity of the display controller for each additional supported ROI. In addition, implementing data integrity check functionality in fixed function hardware limits changes to the data integrity check algorithm, as any changes would require an update to the hardware.

Further, a display background image is typically rendered separately from an ROI and then composited (blended) with the ROI(s) at the display controller. If safety-critical information at an ROI is overlayed on a dynamic background, such as a map that is changing as the vehicle in which the display system is installed moves through the environment, a data integrity check on the composited image could lead to an incorrect result.

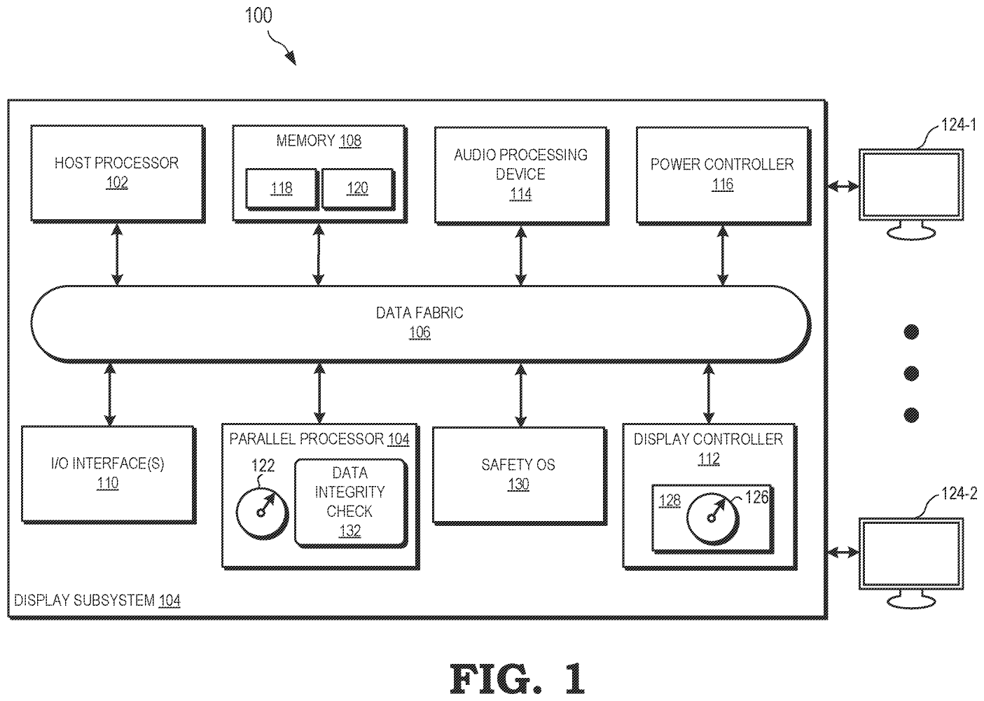

FIGS. 1-6 illustrate techniques for increasing a number of supported regions of interest and allowing for a dynamic background image by offloading ROI calculations and data integrity checks from a display controller to a parallel processor of a display system. In some implementations, the parallel processor calculates a configurable number of regions of interest of a frame and error checks each of the regions of interest before transmitting the frame to a display controller. The display controller receives the frame from the parallel processor and transmits the frame to a display device for display. In some implementations, the parallel processor overlays the regions of interest on a dynamic background to generate a blended frame that includes both the dynamic background and the ROI(s). The parallel processor performs a first cyclic redundancy check (CRC) on each of the regions of interest at a first shader engine in some implementations and performs a second CRC on each of the regions of interest at a second shader engine to redundantly check the integrity of safety-critical data at the ROI(s). In some implementations, the parallel processor performs the CRCs by calculating a CRC value for each of the regions of interest and sending the CRC value to an external component of the display system for comparison to a reference value. To further increase the robustness of the safety-critical data integrity checks, in some cases the display system includes a serializer/deserializer (SERDES) that receives the frame from the display controller and transmits the frame to the display that is configured to perform a third CRC on each of the ROIs.

Implementing ROI calculations and data integrity checks at the parallel processor increases the number of ROIs supported by the display system, increases the number of display pipes available to drive displays, allows for simplified updates to a data integrity check algorithm, and increases the robustness of the data integrity checks by increasing redundancies both within the parallel processor and across components of the display system. Further, by offloading ROI calculations and data integrity checks from fixed function hardware of the display controller, the display controller itself can be simplified, resulting in lower cost, die area, and complexity.

FIG. 1 illustrates a block diagram of a display system 100 in which region of interest data integrity checking is offloaded from a display controller to a parallel processor in accordance with some implementations. The display system 100, in at least some implementations, includes at least one or more processing devices, such as a host processor 102 and a parallel processor 104, a fabric 106, memory 108, an input/output (I/O) interface(s) 110, a display controller 112, an audio processing device 114, a power controller 116, and the like. The display system 100, in at least some implementations, is a computer, laptop, mobile device, server, vehicle human-machine interface, or any of various other types of computing systems or devices. It is noted that the number of components of the display system 100 may vary. It is also noted that in implementations, display system 100 includes other components not shown in FIG. 1, and the display system 100, in at least some implementations, is structured differently than shown in FIG. 1.

The fabric 106 is representative of any communication interconnect that complies with any of various types of protocols utilized for communicating among the components of the display system 100. The fabric 106 provides the data paths, switches, routers, and other logic that connect the host processor 102, parallel processor 104, memory 108, input/output (I/O) interface(s) 110, display controller 112, audio processing device 114, power controller 116, and other devices to each other. The fabric 106 handles the request, response, and data traffic, as well as probe traffic to facilitate coherency. Interrupt request routing and configuration of access paths to the various components of the display system 100 are also handled by the fabric 106. Additionally, the fabric 106 handles configuration requests, responses, and configuration data traffic. In at least some implementations, the fabric 106 is bus-based, including shared bus configurations, crossbar configurations, and hierarchical buses with bridges. In other implementations, the fabric 106 is packet-based and hierarchical with bridges, crossbar, point-to-point, or other interconnects. From the point of view of the fabric 106, the other components of display system 100 are referred to as “clients”. The fabric 106 is configured to process requests generated by various clients and pass the requests on to other clients.

The memory 108 includes system memory or another storage component that is implemented using a non-transitory computer readable medium, such as dynamic random-access memory (DRAM), Static Random Access Memory (SRAM), NAND Flash memory, NOR (Not Or) flash memory, Ferroelectric Random Access Memory (FeRAM), or others. The I/O interface(s) 110 is representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to the I/O interface(s) 110. Such peripheral devices include (but are not limited to) displays, keyboards, mice, printers, scanners, joysticks or other types of game controllers, media recording devices, external storage devices, network interface cards, and so forth.

The audio processing device 114, such as an audio controller, generates audio signals that can be output by the audio processing device 114 or another component of the display system 100. The power controller 116, such as a system management unit (SMU) or another type of power controller, includes hardware and firmware for managing and accessing system configuration/status registers and memories, generating clock signals, controlling power rail voltages, and the like for the display system 100. The power controller 116 also controls the power supplied to components and sub-components of the display system 100, such as the cores of the host processor 102, parallel processor 104, the I/O interface 110, the display controller 112, and the like.

The host processor 102, in at least some implementations, is a processor such as a central processing unit (CPU) and supports the execution of instructions for graphics and other types of workloads. For example, the host processor 102 executes instructions, such as program code 118, stored in the memory 108 and stores information in the memory 108, such as the results of the executed instructions. In another example, the host processor 102 prepares and distributes one or more operations to the parallel processor 104 (or other computing resources) and then retrieves the results of one or more operations from the parallel processor 104. The host processor 102 is also able to initiate graphics processing by issuing draw calls. In at least some implementations, the host processor 102 includes multiple processing elements (not shown in FIG. 1 in the interest of clarity) that execute instructions concurrently or in parallel. The processing elements are referred to as processor cores, compute units, or using other terms.

The parallel processor 104, in at least some implementations, is a processor such as a vector processor, a graphics processing unit (GPU), a general-purpose GPU (GPGPU), a non-scalar processor, a highly-parallel processor, an artificial intelligence (AI) processor, an inference engine, a machine learning processor, another multithreaded processing unit, a digital signal processor (DSP), a field programmable gate array (FPGA), an application specific integrated circuit (ASIC), or the like. The parallel processor 104, in at least some implementations, is constructed as a multi-chip module (e.g., a semiconductor die package) including two or more base integrated circuit (IC) dies communicably coupled together with bridge chip(s) or other coupling circuits or connectors such that a parallel processor is usable (e.g., addressable) like a single semiconductor integrated circuit. As used herein, the terms “die” and “chip” are interchangeably used. Those skilled in the art will recognize that a conventional (e.g., not multi-chip) semiconductor integrated circuit is manufactured as a wafer or as a die (e.g., single-chip IC) formed in a wafer and later separated from the wafer (e.g., when the wafer is diced); multiple ICs are often manufactured in a wafer simultaneously. The ICs and possibly discrete circuits and possibly other components (such as non-semiconductor packaging substrates including printed circuit boards, interposers, and possibly others) are assembled in a multi-die parallel processor.

In at least some implementations, the parallel processor 104 is an accelerated processor (AP) that combines, for example, a general-purpose CPU and a GPU. The AP accepts both compute commands and graphics rendering commands from the host processor 102 or another processor. The AP includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. The AP and the host processor 102, in at least some implementations, are formed and combined on a single silicon die or package to provide a unified programming and execution environment. In other implementations, the AP and the host processor 102 are formed separately and mounted on the same or different substrates.

The parallel processor 104 includes one or more processing elements, such as an array of compute units (not shown in FIG. 1 in the interest of clarity) that execute instructions concurrently or in parallel. Shader engines (not shown) of the parallel processor 104 are implemented using shared hardware resources of the parallel processor 104 such as compute units. In some implementations, the shader engines are used to implement shaders, such as geometry shaders, pixel shaders, and the like. Some implementations of the parallel processor 104 are used for general-purpose computing. The parallel processor 104 executes instructions stored in the memory 108 and stores information in the memory 108, such as the results of the executed instructions. For example, the memory 108 stores a copy of instructions that represent program code of an application 120 including a compositor (not shown) that is to be executed by the parallel processor 104. The parallel processor 104 also includes a timing reference/generator 122.

The parallel processor 104, among other things, renders images and generates a stream of frames for presentation by one or more display devices 124 (illustrated as display device 124-1 and display device 124-2), which may include, for example, a screen, a monitor, a television, etc. For example, the parallel processor 104 renders objects to produce values of pixels that are provided by the display controller 112 to the one or more display devices 124, which use the pixel values to display an image that represents the rendered objects. In implementations where multiple display devices 124 are coupled to the display system 100, the parallel processor 104 generates the same image(s) to be presented on each display device 124 or generates a different image(s) to be presented on two or more of the display devices 124.

The display controller 112 reads out the pixel values in the frames from an output buffer/memory and uses the values to generate one or more signals for displaying an image on (or presenting an image to) the display device 124. The display controller 112 provides the video signal representing the frames via a physical interface, such as a high-definition multimedia interface (HDMI) or DisplayPort interface, coupled to the display devices 124. The display controller 112 includes one or more timing references 126 that generate control signals, synchronization signals, clock signals (independently or in conjunction with other circuitry or devices), a combination thereof, or the like that are required for interfacing to the display device 124. In at least some implementations, the one or more timing references 126 are synchronized to, for example, the parallel processor timing reference 122 (or another timing reference) during normal operation. Some implementations of the timing reference 126 are implemented in a timing controller (TCON) chip 128, e.g., as an ASIC or other circuit, which also performs timing and synchronization operations for the display device 124. Although the display controller 112 is illustrated in FIG. 1 as being separate from other components of the display system 100, the display controller 112, in other examples, is part of another component(s), such as the parallel processor 104, the I/O interface 110, or the like.

In some instances, visual content within a frame output by a parallel processor or another processor may not be displayed correctly on a display device. The visual content or a portion thereof may be corrupted, misrepresented, omitted, or the like. Software, including applications and the operating system, running on host processor 102 is typically considered untrusted from a functional safety standpoint. Because this software is involved in the composition and dispatch of content to the display devices 124, it is difficult to prevent the software from potentially disrupting the output of desired visual content of interest. Such disruptions may be caused by a combination of either malicious software or unintentional software bugs. Consider an example where the display system 100 is implemented within a vehicle, such as an automobile or an airplane. In this example, visual content, such as a check engine light, is to be presented on one of the display devices 124 of the vehicle. However, due to malicious software executing on the host processor 102, the check engine light is omitted from the display device 124 or is presented in a corrupted form. In another example, the display system 100 is a gaming system, and the visual content to be presented on the display device 124 is a mini-map within a video game. However, due to malicious software executing on the host processor 102 or a software bug, the mini-map is not displayed or is displayed in the video game with incorrect information.

To facilitate data integrity checking for a configurable number of ROIs, data integrity checking for ROIs overlayed on dynamic backgrounds, and use of a configurable data integrity checking algorithm, the parallel processor 104 is configured to perform a data integrity check 132 to verify that visual content is being presented on the display device 124 as expected. As described in greater detail below, the data integrity check 132 calculates a derived value (e.g., a cyclic redundancy checksum) representing a region of pixel data (e.g., defining the visual COI) corresponding to a region of interest (ROI) specified by the compositor implemented in program code of the application 120 as frames are scanned out to the display interface. The data integrity check 132 sends the ROI coordinates and calculated derived value to a safety operating system (OS) 130 on, for example, a per-frame basis or according to another timing interval. In at least some implementations, the data integrity check 132 transmits the ROI coordinates and calculated derived value to the safety OS 130 using the inter-integrated circuit (I2C) communication protocol or another communication protocol.

In some implementations, the safety OS 130 is a real-time operating system that ensures precise execution of time-dependent tasks. For example, real-time operating systems typically include a clock which starts and stops tasks at regular intervals. The safety OS 130 may implement an interrupt which is asserted to start and stop tasks. The tasks typically include a specified rate of execution and a specified maximum duration. The safety OS 130 starts a task at the specified rate and expects the task to complete within the specified maximum duration so that a new task may be started in some implementations. In some implementations, the safety OS 130 receives the ROI coordinates and calculated derived value from the parallel processor 104 and uses this information to determine if visual COI will be presented correctly on one or more of the display devices 124 based on the signals received from the display controller 112 (e.g., the visual content will be presented without modification, corruption, or misrepresentation). Stated differently, the safety OS 130 determines if a specified region of the display devices 124 will display the expected pixel content (e.g., visual COI). For example, the safety OS 130, in at least some implementations, compares the received derived value to a reference value (i.e., a derived value expected for the ROI coordinates received from the parallel processor 104). If the derived value and the reference value match, the safety OS 130 determines that the visual COI will be displayed correctly. However, if the derived value and the reference value do not match, the safety OS 130 determines that the visual COI will be displayed incorrectly and generates a fault or error notification to initiate restarting a process or restarting the display system 100 in some implementations.

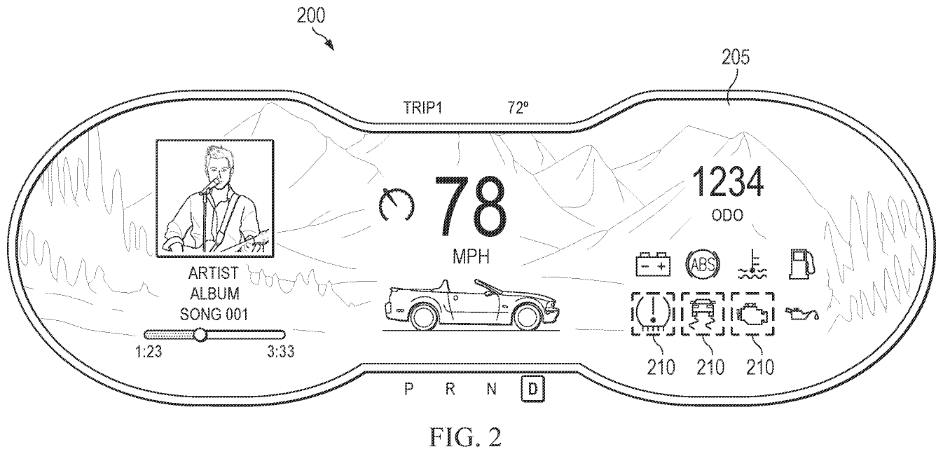

FIG. 2 is an illustration of a display image 200 having multiple regions of interest 210 in accordance with some embodiments. In the illustrated example, the display image 200 includes a dynamic background 205 indicating a speed of a vehicle, an odometer reading, entertainment media that is playing, and one or more tell-tale warning indicators at the regions of interest 210. Examples of tell-tale warning indicators are a check engine indicator, a tire pressure warning indicator, and anti-lock braking system (ABS) indicator. Because the tell-tale warning indicators implicate safety-critical information that could impact a driver's behavior, accuracy of the tell-tale warning indicators is rigorously checked to ensure that timely and appropriate warnings are displayed.

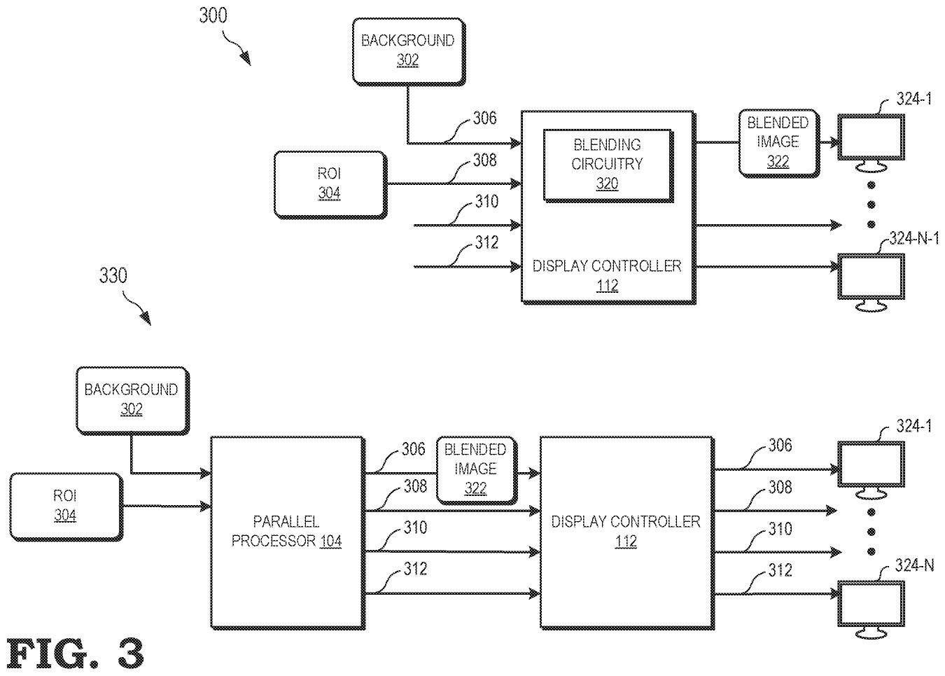

FIG. 3 shows two block diagrams 300, 330 illustrating increasing availability of display controller pipes by offloading region of interest functionality to a parallel processor in accordance with some embodiments. The display controller 112 includes N display pipes, illustrated in the example of FIG. 3 as four display pipes 306, 308, 310, 312. Each display pipe includes, e.g., screen data transfer logic and a buffer (not shown). The screen data transfer logic transfers data from the buffer to an associated display 324. The buffer stores pixel data for the screen data transfer logic to transmit to the display 324. Each display pipe 306, 308, 310, 312 is configured to transmit pixel data to a different display 324 when such a display 324 is connected to the display controller 112. In one example, an operating system is set up to spread the same or different image frames across multiple display devices 324. Each display pipe 306, 308, 310, 312 provides pixel data for the portion of the image frame appropriate for that display 324. In this mode of operation, the display pipes 306, 308, 310, 312 operate concurrently, each transmitting data to the associated display 324 during the appropriate display period.

The block diagram 300 illustrates a portion of a conventional display system in which the display controller 112 receives a background image 302 for a frame at a first pipe 306 and one or more ROIs 304 to be displayed with the first frame at a second pipe 308. The display controller 112 includes blending circuitry 320 that implements fixed function hardware to composite the one or more ROIs 304 with the background image 302 to form a blended image 322. However, because the background image 302 and the one or more ROIs 304 are each transmitted along separate display pipes 306, 308 of the display controller 112, two of the display pipes are used for a single merged image frame, such that the maximum number of display devices that the display controller 112 can drive is reduced to N−1.

The block diagram 330 illustrates a portion of a display system in which the merging function of the display controller blending circuitry 320 is offloaded to the parallel processor 104 such that the output of the parallel processor 104 is the blended image 322. The blended image 322 is input to the display controller 112 at a single display pipe 306, such that the remaining display pipes 308, 310, 312 are available to drive additional (up to N) display devices. Thus, by offloading the merging function from the display controller 112 to the parallel processor 104, the display system increases the number of displays that can be driven by the display controller 112 and reduces the amount of fixed function hardware of the display controller 112.

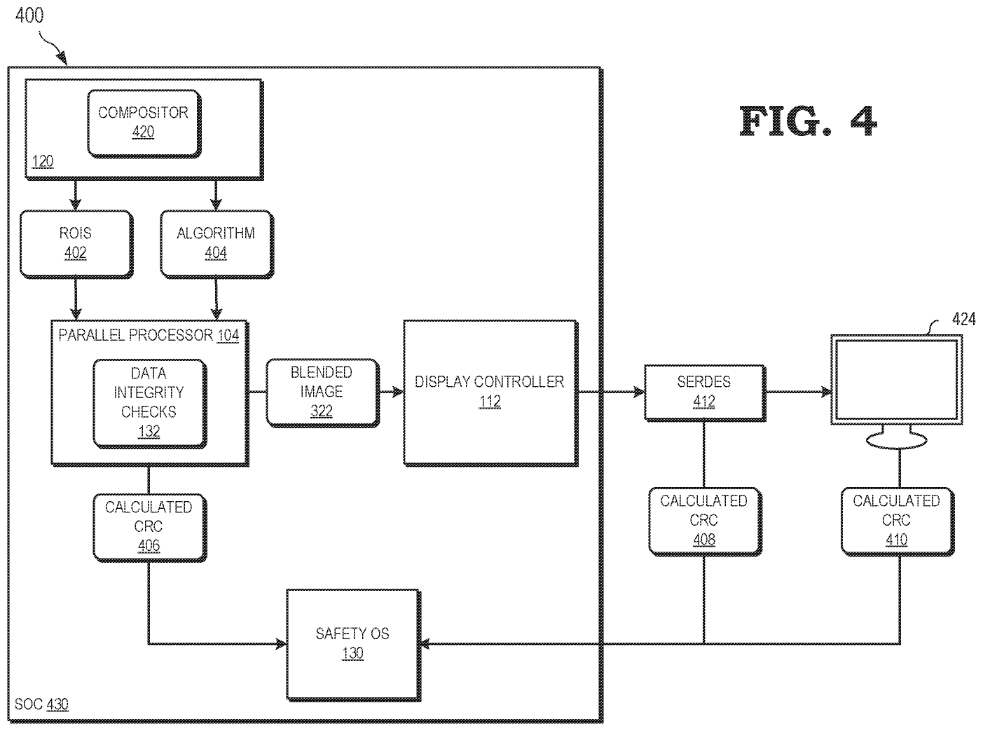

FIG. 4 is a block diagram of a portion 400 of a display system illustrating redundant data integrity checking for regions of interest at a parallel processor 104, at a serializer/deserializer (SERDES) 412, and at a display 424 in accordance with some embodiments. In some implementations, the parallel processor 104, display controller 112, and safety OS 130 are included in a system-on-a-chip (SOC) 430, while the SERDES 412 and display device 424 are external components to the SOC 430. In the illustrated example, an application 120 executing at the display system 100 includes a compositor 420 that determines, on a frame-by-frame basis, how many ROIs 402 (if any) are to be included in the frame and an algorithm 404 to be used to check the data integrity of the frame and any ROIs 402.

In contrast to the display controller 112, which conventionally uses fixed function hardware to calculate a CRC using a fixed algorithm for a number of ROIs that is limited by the number of display pipes of the display controller 112, the parallel processor 104 is able to calculate CRCs for larger (configurable) number of ROIs using a programmable algorithm without additional hardware. Further, by offloading data integrity checks for ROIs from the display controller 112 to the parallel processor 104, the display controller 112 can omit the fixed function hardware otherwise used for data integrity checks.

The programmability and parallelism of the parallel processor 104 enables the parallel processor 104 to perform a data integrity check 132 on the configurable number of ROIs 402 indicated by the compositor 420 for each frame, using the algorithm 404 specified by the compositor 420 for the frame. For example, if no safety warnings are indicated by the compositor 420 for a frame, the parallel processor 104 does not calculate any data integrity checks for the frame. However, if, for example, a frame contains multiple safety-critical regions of pixels, the compositor 420 may indicate up to M ROIs 402 for the frame. The parallel processor 104 performs data integrity checks 132 on each of the indicated ROIs 402 using the algorithm 404 indicated by the compositor 420. In the illustrated example, the parallel processor 104 calculates a CRC 406 for each ROI 402 of the frame and sends the calculated CRC 406 to the safety OS 130 for comparison to a reference value for each ROI 402. In other implementations, the parallel processor 104 sends the calculated CRC 406 for each ROI 402 of the frame via the I2C communication protocol to a safety OS (not shown) running in an external microcontroller (not shown) for comparison to the reference value for each ROI 402.

The parallel processor 104 also sends the blended image 322 that includes the ROIs 402 and a background image to the display controller 112. The display controller 112 provides the blended image 322 to the SERDES 412 for serialization and deserialization for input to a display device 424. In some implementations, the integrity of the blended image 322 is redundantly checked by components external to the SOC 430 to further ensure that safety-critical ROIs are correctly displayed. To that end, the SERDES 412 also calculates a CRC 408 on the blended image 322. The SERDES 412 transmits the calculated CRC 408 to the safety OS 130 for comparison to a reference value for the blended image 322 as an additional data integrity check.

In some implementations, to ensure that the blended image 322 is not corrupted at the display device 424, the display device 424 performs an additional data integrity check on the blended image 322. For example, in some implementations, the display device 424 calculates a CRC 410 for the blended image 322 and transmits the calculated CRC 410 to the safety OS 130 for comparison to a reference value for the blended image 322. If the calculated CRCs 406, 408, 410 match the corresponding reference values, the safety OS 130 determines that the ROIs 402 will be displayed correctly. However, if any of the calculated CRCs 406, 408, 410 do not match the corresponding reference value, the safety OS 130 determines that the ROIs 402 will not be displayed correctly and generates a fault or error notification to initiate, e.g., restarting a process or restarting the display system 100 in some implementations.

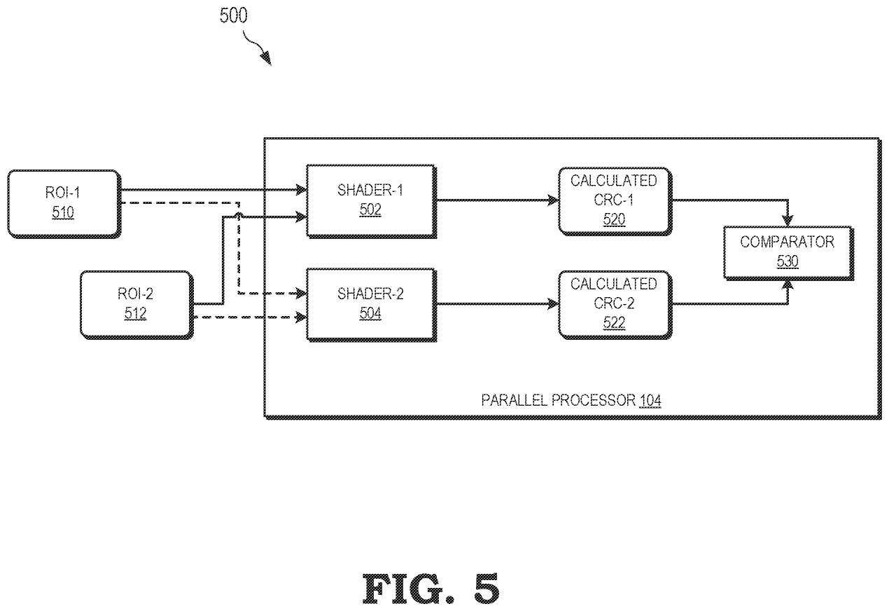

FIG. 5 is a block diagram illustrating redundant data integrity checking 500 within the parallel processor 104 in accordance with some embodiments. To further increase the reliability of data integrity checks 132 performed at the parallel processor 104, in some implementations, the parallel processor 104 redundantly calculates a CRC for each ROI. In the illustrated example, a first input such as an ROI (illustrated as ROI-1 510) and a second input such as ROI-2 512 are input to a shader engine of the parallel processor for a first instance (shader-1 502)—, which calculates a first CRC (calculated CRC-1 520) and spawns a second thread that is input to the shader engine for a second instance (shader-2 504) for redundancy to calculate a second calculated CRC-2 522. The calculated CRC-1 520 and the calculated CRC-2 522 are compared at a comparator 530 to determine if the two outputs match. If the calculated CRC-1 520 and the calculated CRC-2 522 match, then the calculated CRCs are determined to be reliable. In some implementations, only if the calculated CRCs are determined to be reliable (i.e., only if the calculated CRCs match) does the parallel processor 104 send the calculated CRCs to the safety OS 130 for comparison to a reference value for each ROI. If the calculated CRC-1 520 and the calculated CRC-2 522 do not match, then the calculated CRCs are determined to be unreliable. In some implementations, the comparator 530 is implemented in hardware, software, or a combination thereof. In the illustrated example, the comparator 530 is incorporated in the parallel processor 104, but in other implementations, the comparator 530 is included in another component of the display system 100 external to the parallel processor 104.

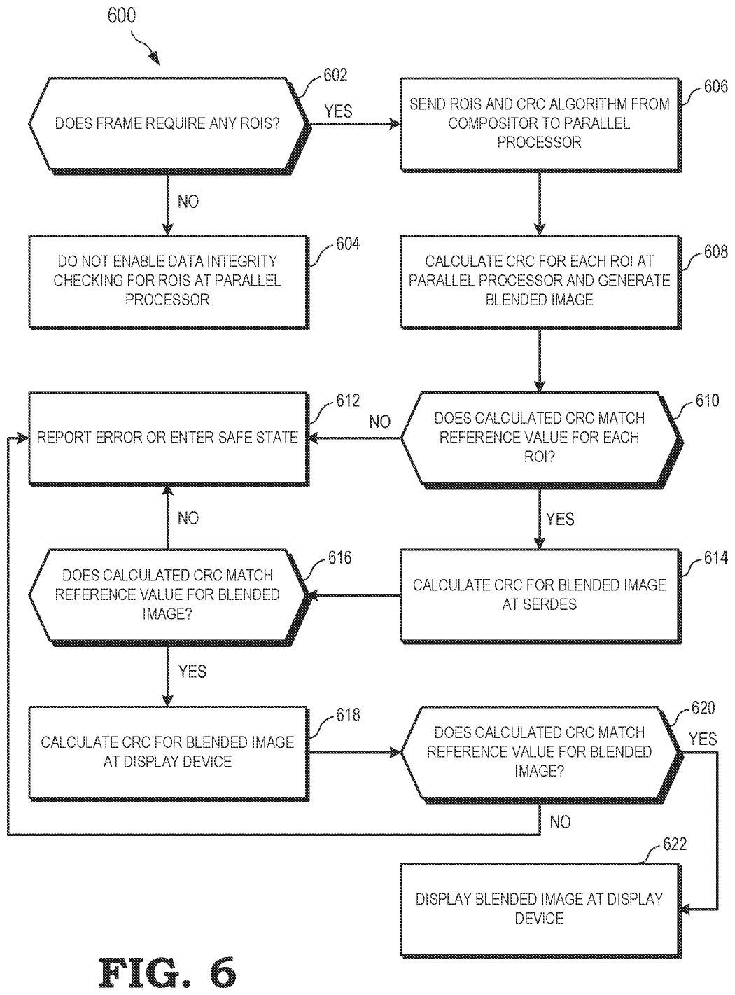

FIG. 6 is a flow diagram illustrating a method 600 for checking safety critical data integrity at a parallel processor of a display system in accordance with some embodiments. For purposes of description, the method 600 is described with respect to an example implementation at the display system 100 of FIG. 1, but it will be appreciated that, in other implementations, the method 600 is implemented at processing systems having different configurations. Also, the method 600 is not limited to the sequence of operations shown in FIG. 6, as at least some of the operations can be performed in parallel or in a different sequence. Moreover, in at least some implementations, the method 600 can include one or more different operations than those shown in FIG. 6.

At block 602, the compositor 420 determines whether a current frame requires an ROIs 402. In some implementations, the compositor 420 receives information from one or more sensors that indicate whether safety-critical information should be conveyed to a user via one or more ROIs 402. If, at block 602, the compositor 420 determines that the current frame does not require any ROIs 402, the method flow continues to block 604. At block 604, data integrity checking for ROIs is not enabled at the parallel processor 104. If, at block 602, the compositor 420 determines that one or more ROIs 402 should be included in the current frame, the method flow continues to block 606.

At block 606, the compositor 420 determines how many ROIs 402 to include in the current frame and an algorithm 404 to be applied for checking the integrity of data associated with each of the ROIs 402. The compositor 420 sends the configurable number of ROIs 402 and the algorithm 404 to the parallel processor 104. At block 608, the parallel processor 104 performs a data integrity check 132 on each ROI 402 indicated by the compositor 420 using the indicated algorithm 404. For example, in some implementations, the parallel processor 104 calculates a CRC 406 for each ROI 402 using the algorithm 404. In addition, the parallel processor 104 generates a blended image 322 by merging the one or more ROIs 402 with a background image 302. The parallel processor 104 provides the CRC(s) 406 to the safety OS 130 and provides the blended image 322 to the display controller 112.

At block 610, the safety OS 130 compares the calculated CRC 406 for each ROI 402 to a reference value and determines whether they match. If, at block 610, the safety OS 130 determines that the calculated CRC 406 for one or more ROI 402 does not match the reference value, the method flow continues to block 612. At block 612, the safety OS 130 signals the parallel processor 104 to indicate a fault or error, and to initiate restarting a process or restarting the display system 100 in some implementations. In other implementations, the safety OS 130 signals the parallel processor 104 to enter a safe state.

If, at block 610, the safety OS 130 determines that the calculated CRC 406 for each ROI 402 matches the corresponding reference value for the ROI 402, the method flow continues to block 614. At block 614, after the display controller 112 has provided the blended image 322 to the SERDES 412, the SERDES 412 performs a data integrity check for the blended image 322. For example, in some implementations, the SERDES 412 calculates a CRC 408 for the blended image 322 and provides the calculated CRC 408 to the safety OS 130.

At block 616, the safety OS 130 compares the calculated CRC 408 to a reference value for the blended image 322 and determines whether the values match. If, at block 616, the safety OS 130 determines that the calculated CRC 408 does not match the reference value for the blended image 322, the method flow continues back to block 612. If the safety OS 130 determines at block 616 that the calculated CRC 408 matches the reference value for the blended image 322, the method flow continues to block 618.

At block 618, after the SERDES 412 provides the blended image 322 to the display device 424, the display device 424 calculates a CRC 410 for the blended image 322 and provides the calculated CRC 410 to the safety OS 130 for an additional data integrity check on the blended image 322. At block 620, the safety OS 130 compares the calculated CRC 410 to a reference value for the blended image 322 and determines whether the values match. If, at block 620, the safety OS 130 determines that the calculated CRC 410 does not match the reference value for the blended image 322, the method flow continues back to block 612. If the safety OS 130 determines at block 620 that the calculated CRC 410 matches the reference value for the blended image 322, the method flow continues to block 622. At block 622, after the individual ROIs 402 and the blended image 322 have passed redundant data integrity checks at multiple points in the graphics pipeline, the display device displays the blended image 322.

In some embodiments, the apparatus and techniques described above are implemented in a system including one or more integrated circuit (IC) devices (also referred to as integrated circuit packages or microchips), such as the display system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
calculating, at a parallel processor of a display system, a configurable number of regions of interest of a frame;
error checking each of the regions of interest at the parallel processor; and
transmitting the frame to a display controller of the display system for display.

2. The method of claim 1, further comprising:
overlaying the regions of interest on a dynamic background.

3. The method of claim 1, wherein error checking comprises:
performing, at a shader engine of the parallel processor, a first data integrity check on each of the regions of interest.

4. The method of claim 3, wherein performing the first data integrity check comprises:
calculating a first cyclic redundancy check (CRC) value for each of the regions of interest; and
comparing, at an external component of the display system, the first CRC value to a reference value.

5. The method of claim 4, further comprising:
calculating a second CRC value for each of the regions of interest; and
comparing the second CRC value to the first CRC value, wherein comparing the first CRC value to the reference value is in response to the second CRC value matching the first CRC value.

6. The method of claim 1, further comprising:
transmitting the frame from the display controller to a display via a serializer/deserializer.

7. The method of claim 6, further comprising:
calculating, at the serializer/deserializer, a cyclic redundancy check (CRC) value for each of the regions of interest; and
sending the CRC value to an external component of the display system for comparison to a reference value.

8. A processing system, comprising:
a parallel processor configured to:
calculate a configurable number of regions of interest of a frame; and
error check each of the regions of interest; and
a display controller to receive the frame from the parallel processor and transmit the frame to a display.

9. The processing system of claim 8, wherein the parallel processor is further configured to:
overlay the regions of interest on a dynamic background.

10. The processing system of claim 8, wherein the parallel processor is further configured to:
perform, at a shader engine, a first data integrity check on each of the regions of interest.

11. The processing system of claim 10, wherein the parallel processor is to perform the first data integrity check by:
calculating a first cyclic redundancy check (CRC) value for each of the regions of interest; and
sending the first CRC value to an external component of the processing system for comparison to a reference value.

12. The processing system of claim 11, wherein the parallel processor is further configured to:
calculate a second CRC value for each of the regions of interest; and
compare the second CRC value to the first CRC value, wherein sending the first CRC value to the external component is in response to the second CRC value matching the first CRC value.

13. The processing system of claim 8, further comprising:
a serializer/deserializer configured to receive the frame from the display controller and transmit the frame to the display.

14. The processing system of claim 13, wherein the serializer/deserializer is further configured to:
calculate a cyclic redundancy check (CRC) value for each of the regions of interest; and
send the CRC value to an external component of the processing system for comparison to a reference value.

15. A display system, comprising:
a parallel processor configured to:
calculate a configurable number of regions of interest of a frame; and
perform, at a shader engine, a first data integrity check using a configurable algorithm on each of the regions of interest.

16. The display system of claim 15, wherein the parallel processor is further configured to:
overlay the regions of interest on a dynamic background.

17. The display system of claim 15, wherein the parallel processor is to perform the first data integrity check by:
calculating, at the shader engine, a first cyclic redundancy check (CRC) value for each of the regions of interest; and
sending the first CRC value to an external component of the display system for comparison to a reference value.

18. The display system of claim 17, wherein the parallel processor is further configured to:
calculate, at the shader engine, a second CRC value for each of the regions of interest; and
compare the first CRC value to the second CRC value, wherein sending the first CRC value to the external component is in response to the first CRC value matching the second CRC value.

19. The display system of claim 15, further comprising:
a display controller configured to receive the frame from the parallel processor; and
a serializer/deserializer configured to receive the frame from the display controller and transmit the frame to a display.

20. The display system of claim 19, wherein the serializer/deserializer is further configured to:
calculate a cyclic redundancy check (CRC) value for each of the regions of interest; and
send the CRC value to an external component of the display system for comparison to a reference value.
